(19) United States
(12) Patent Application Publication
(10) Pub. No.: US 2008/0309828 A1
(43) Pub. Date: Dec. 18, 2008

(54) Broadcast Signal Receiving Apparatus

(75) Inventors: Shusuke NARITA, Daito-shi (JP); Kenji OKAMOTO, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/137,150

(22) Filed: Jun. 11, 2008

(30) Foreign Application Priority Data
Jun. 12, 2007 (JP) 2007-155428

(51) Int. Cl. H04N 5/50

(52) U.S. Cl. 348/731; 348/E05.097

(57) ABSTRACT

A broadcast signal receiving apparatus 1 can simplify up-and-down channel selection corresponding to operations of an up key 21a or a down key 21b by a user without increasing cost. The broadcast signal receiving apparatus 1 comprises a channel selector (primary controller) 8 that performs the up-and-down channel selection. The channel map information includes an addition or deletion flag for each channel included in the channel map information. The channel selector 8 confirms the addition or deletion flag of each channel when the up key 21a or the down key 21b is operated by the user, and ignores the channel that the addition or deletion flag is set in deletion in the up-and-down channel selection.

### BACKGROUND OF THE INVENTION

1. Field of the Invention

The present invention relates to a broadcast signal receiving apparatus that receives video signals and audio signals included in broadcast signal and outputs them to a monitor display apparatus, for example.

2. Description of the Related Art

In transition period from analogue broadcasting to digital broadcasting, programs having the same contents but modulation systems are different each other are delivered simultaneously in both of an analogue broadcasting channel and a digital broadcasting channel. For a broadcast signal receiving apparatus corresponding to digital. broadcasting, there is no merit to select the program of analogue broadcasting in view of image quality and sound quality. In up-and-down channel selection that a user selects a desired channel by operating up key and/or down key of a remote controller, if all channels included in both of analogue broadcasting and digital broadcasting is sequentially selected, it is very troublesome because the same programs are sequentially displayed on a screen of a monitor display apparatus.

Therefore, in a conventional broadcast signal receiving apparatus shown in JP 2001-189894, for example, each program in each receivable channel is judged whether it is delivered as standard television (SDTV) broadcasting or high definition television (HDTV) broadcasting based on electronic program guide information, and the programs which are delivered as the HDTV broadcasting are grouped in a single channel in the up-and-down channel selection. According to such operation, since and the programs which are delivered as the HDTV broadcasting are grouped in a single channel, it becomes convenient to select the HDTV programs. However, since the process that the broadcast signal receiving apparatus performs in the channel selection is complex, it requires a high-speed processor which causes expensiveness of the apparatus.

### SUMMARY OF THE INVENTION

The present invention is conceived to solve the above mentioned conventional problem, and aimed to provide a broadcast signal receiving apparatus which enables to simplify the operation by the user in the up-and-down channel selection, and thus, to increase the usability of the apparatus.

A broadcast signal receiving apparatus in accordance with an aspect of the present invention comprises:

a video and audio signal receiver that receives video signals and audio signals included in broadcast signal;

a control signal receiver that receives broadcast control signal included in the broadcast signal;

a control signal processor that processes the broadcast control signal;

a channel map information creature that creates channel map information including information of channels, broadcast signals of which are receivable based on signals processed by the control signal processor;

a memory that stores the channel map information;

up and down keys used by a user to select a channel that broadcast signal thereof is received by the video and audio signal receiver; and

a channel selector that select the channel corresponding to operation of the up or down key opoperated by the user, wherein the channel map information includes am addition or deletion flag for each channel registered in the channel map information by the channel selector, which is used to judge whether the channel is reflected in channel selecting operation or not when the up or down key is operated by the user;

when the addition or deletion flag of a channel is in addition, the channel selector reflects the channel in the channel selecting operation; and

when the addition or deletion flag of a channel is in deletion, the channel selector does not reflect the channel in the channel selecting operation.

According to such a configuration, when the up key or the down key is operated by the user, the channel selector confirms the addition or deletion flag of each channel and judges whether the channel is reflected or not in the channel selecting operation or not corresponding to the condition of the addition or deletion flag, so that it enables to simplify the process in the channel selector. Thereby, although an inexpensive processor which is not so high-speed can be used for the channel selector, it is possible to increase the usability of the broadcast signal receiving apparatus.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a block diagram showing a configuration of a broadcast signal receiving apparatus in accordance with an embodiment of the present invention;

FIG. 2A is a diagram showing a part of the channel map information stored in a memory;

FIG. 2B is a diagram showing correspondence between source IDs and names of TV stations;

FIG. 3 is a perspective view showing a configuration of a remote controller including up and down keys;

FIG. 4 is a flowchart showing processes that a primary controller (processor) serving as a channel map information creator in creating or updating of channel map information; and

FIG. 5 is a flowchart showing processes that the primary controller serving as a channel selector in disabling channel selection of analogue television broadcasting channel.

### DETAILED DESCRIPTION OF THE EMBODIMENT

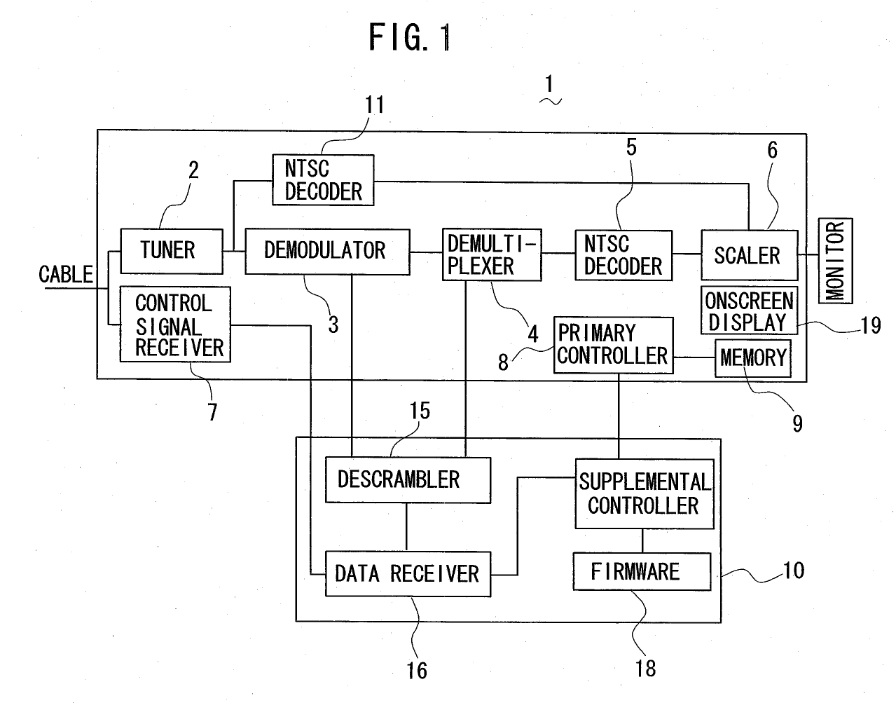

A broadcast signal receiving apparatus in accordance with an embodiment of the present invention is described with reference to the figures. FIG. 1 shows a block configuration of the broadcast signal receiving apparatus 1 that receives television broadcast signals delivered through a cable, for example.

The broadcast signal receiving apparatus 1 comprises the following elements. A tuner 2 tunes broadcast signal of a channel that the user selects, and receives video signals and audio signals included in the broadcast signal. A demodulator 3 demodulates the broadcast signal outputted from the tuner 2 to digital data of MPEG-TS. A demultiplexer 4 takes out data of the channel that the user selects among the multiplexed digital data of MPEG-TS. A MPEG decoder 5 decodes the digital data of MPEG-TS to video signals. A scaler 6 converts image size of the video signals outputted from the MPEG decoder 5 corresponding to an output device of a monitor display apparatus and outputs the converted video signals to the monitor display apparatus. A control signal receiver 7 receives broadcast control signal included in the broadcast signal transmitted from a local provider of a cable cast, and decodes the broadcast control signal. A primary controller 8 is configured of a CPU and so on, and controls the above mentioned elements. A memory 9 stores information processed in the controller. A control signal processor 10 is formed as a card shape and inserted into a slot provided on a main frame of the broadcast signal receiving apparatus 1. The control signal processor 10 processes the broadcast control signal received by the control signal receiver 7.

The broadcast signal receiving apparatus 1 accepts both of digital broadcasting and analogue broadcasting, for example, so that it comprises an NTSC decoder 11 that decodes analogous broadcast signals (NTSC) to video signals.

The control signal processor 10 is a card shaped signal processing device called “cable card” and loaned to a used by a cable television provider who contracts with the provider. The control signal processor 10 comprises a descrambler 15 that descrambles the broadcast signal such as pay-TV or pay-cable among the broadcast signals demodulated by the demodulator 3, a data receiver 16 that transmits the broadcast control signal outputted from the control signal receiver 7 to the descrambler 15 and a supplemental controller 17 which controls each element of the control signal processor 10, and a firmware 18 of the supplemental controller 17.

In addition, an on-screen displayer 19 is further provided to display a channel map information on a screen of a monitor display apparatus, when a user desires. Details of the channel map information will be described later.

When the control signal processor 10 is attached to the main frame of the broadcast signal receiving apparatus 1, the descrambler 15 is activated, so that digital broadcast signals can be processed sequentially by the tuner 2, demodulator 3, descrambler 15, demultiplexer 4, MPEG decoder 5 and scaler 6 and outputted to the monitor display apparatus. On the other hand, a broadcast control signal including information relating to receivable channels is processed sequentially by the control signal receiver 7, data receiver 16, supplemental controller 17, and primary controller 8.

The primary controller 8 serves as a channel map information creator that crates channel map information based on information relating to receivable channels outputted from the supplemental controller 17, and stores the channel map information into the memory 9. The primary controller 8 displays channel map information on a screen of the monitor display apparatus with using the channel map information stored in the memory 9 corresponding to request by the user. In addition, the primary controller 8 serving as a channel map information creator further includes channel selection function, that is, the primary controller 8 serves as a channel selector.

Since the broadcast control signals are delivered from TV stations regularly at interval of several tens seconds, for example, the primary controller 8 updates the channel map information whenever the broadcast signal receiver 7 receives the broadcast control signal. At the present time, analogue broadcasting and digital broadcasting coexist, so that the same programs which are different the modulation systems such as NTSC of analogue broadcasting and 64QAM and 256QAM of digital broadcasting are delivered simultaneously.

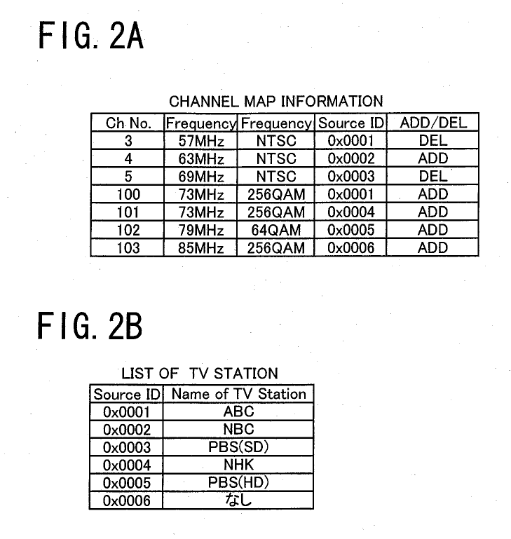

FIG. 2A shows an example of a part of channel map information and FIG. 2B shows an example of an event information table (EIT) that shows correspondence between source IDs and names of TV stations. As shown in FIG. 2A, the channel map information is configured by information relating to each channel such as a channel number, frequency of broadcast signal delivered from a TV station, modulation system of the broadcast signal, source ID, addition or deletion flag (ADD/DEL flag), and a name of the TV station. Among the channel map information, the channel numbers, frequencies, modulation systems and names of TV stations can be displayed on a screen of a monitor display apparatus.

A source ID is applied to a TV station even though the TV station delivers a plurality of channels. In the example shown in FIGS. 2A and 2B, channel 3 of analogue broadcasting and channel 100 of digital broadcasting which are delivered from the same TV station “ABC” are applied the same source ID “0×0001”, as a general rule. On the other hand, channel 5 of analogue broadcasting and channel 102 of digital broadcasting which are delivered from the same TV station “PBC” are respectively applied different source IDs “0×0003” and “0×0005”, in an exceptional rule. In the latter case, a subjoinder such as “(SD)” is added at ending of name of the TV station of analogue broadcasting, and a subjoinder such as “(HD)” is added at ending of name of the TV station of digital broadcasting.

The addition or deletion flag is provided to judge whether a channel is reflected to channel selecting operation or not when an up key 21a or a down key 21b of the remote controller 25 is operated. When the addition or deletion flag is in addition (ADD), the operation of the up key 21a or the down key 21b is reflected in the channel selection operation, and when the addition or deletion flag is in deletion (DEL), the operation of the up key 21a or the down key 21b is not reflected in the channel selecting operation. Specifically, it is assumed that the channel 4 is selected so that a program of the channel is displayed on the screen of the monitor display apparatus. When the user operated the down key 21b, since the addition or deletion flag of the channel 5, which is listed subsequent to the channel 4 in the channel map information shown in FIG. 2A, is in the deletion, the primary controller 8 serving as the channel selector ignores the channel 5, and selects the channel 100, which is listed subsequent to the channel 5 in the channel map information shown in FIG. 2A. That is, the channel 5 that the addition or deletion flag thereof is in the deletion is not reflected in the channel selecting operation. On the other hands, the channel 3, channel 100 and so on that the addition or deletion flag thereof is in the deletion are selected, that is, reflected in the channel selecting operation. Hereupon, the channel that the addition or deletion flag thereof is in the deletion is not selected in the channel selection by operating the up key 21a or the down key 21b, but the channel information of the channel is not deleted from the channel map information.

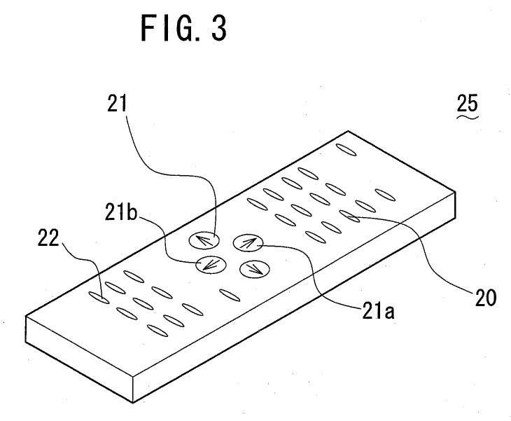

FIG. 3 shows the remote controller 25 which is used to input an instruction to the primary controller 8 of the broadcast signal receiving apparatus 1. The remote controller 25 has a plurality of channel selection keys 20 to which predetermined channels are distributed, four directional keys 21 which are used to up or down various control parameters such as volume of sounds, brightness, contrast or tint of images, and so on, and a plurality of mode selection keys 22 to which various operation mode such as channel selection, volume control of the sounds, brightness, contrast or tint control of the images, and so on are distributed. The above mentioned up key 21a and the down key 21b are included in the four directional keys 21. In order to select a channel by the up-and-down channel selection, a mode selection key 22 to which the channel selection is distributed is pushed first. Then, the primary controller 8 serves as the channel selector, so that the primary controller 8 responds to the operation of the up key 21a or the down key 21b operated by the user.

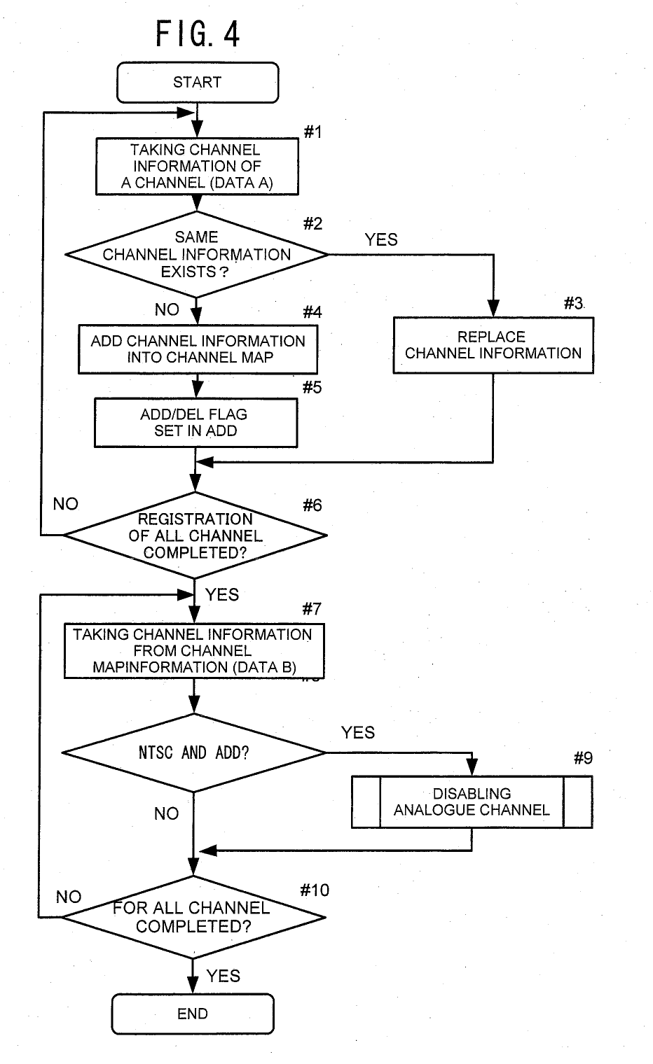

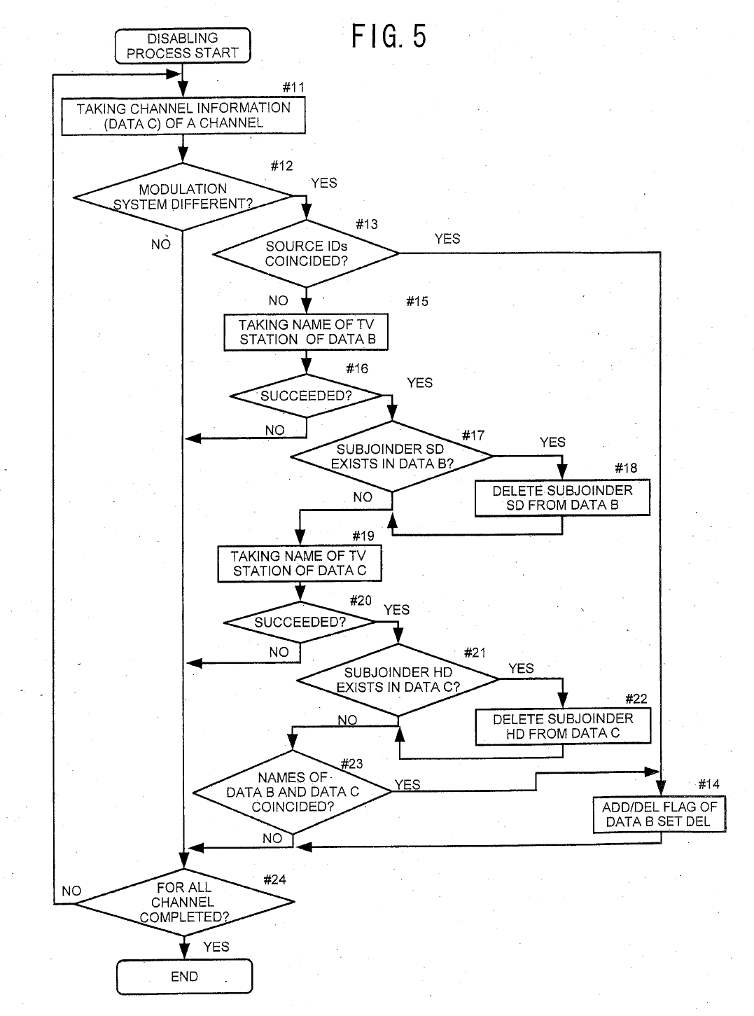

Subsequently, creating or updating of the channel map information by the primary controller 8 serving as a channel map information creator is described with reference to flowcharts shown in FIGS. 4 and 5.

When creating or updating process of the channel map information starts, the primary controller 8 serving as the channel map creator takes channel information of a predetermined channel from broadcast control signals included in out of bands of broadcast signals delivered from a provider of cable cast, and the obtained channel information is temporarily memorized as “dataA” (step #1). Hereupon, each broadcast signal of a channel generally consists of audio signal and video signal (band) and the broadcast control signal (out of bands). The predetermined channel is generally a channel having the smallest channel number among the channels listed in the channel map information or included in the broadcast control signals in the out of bands of the broadcast signals, and sequentially shifted to another channel having a larger channel number.

Then, the primary controller 8 judges whether channel information having the same channel number and the same modulation system as those of the obtained channel information exists or not (step #2). When the channel information having the same channel number and the same modulation system as those of the obtained channel information exists in the channel map information (YES in step #2), the primary controller 8 replaces the channel information previously existed in the channel map information to the data A, that is, the channel information newly obtained (step #3), and proceeds to step #6. On the other hand, when the channel information having the same channel number and the same modulation system as those of the obtained channel information does not exist in the channel map information (NO in step #2), since the channel is newly receivable, the primary controller 8 adds or registers the channel information into the channel map information (step #4). Simultaneously, the primary controller 8 sets an addition or deletion flag of the channel to addition (step #5). Thus, a new receivable channel is added into a channel map. The processes from step #1 to #5 are repeated until all the channels that the broadcast control signals thereof are included in the out of bands of the broadcast signals are registered in the channel map (NO in step #6).

When all the channels are registered in the channel map, (YES in step #6), the primary controller 8 takes channel information of a channel from the channel map information as “data B” (step #7), and judges whether the modulation system in the data B is NTSC or not, for example, and further judges whether the addition or deletion flag in the data B is addition or not (step #8). When the modulation system is NTSC and the addition or deletion flag in the data B is addition (YES in step #8), the primary controller 8 performs channel selection disabling process of a channel of analogue broadcasting shown in FIG. 5 (step #9). When the modulation system of the channel is not NTSC (NO in step #8), the primary controller 8 skips the step #9 and proceeds to step #10. The processes from step #7 to #9 are repeated for all the channels registered in the channel map information (NO in step #10). When the processes from step #7 to #9 are repeated for all the channels, the primary controller 8 completes the creating -or updating process of the channel map information.

FIG. 5 shows channel selection disabling process for a channel of analogue broadcasting in the step #9. The primary controller 8 takes channel information of a channel other than the channel of the data B as “data C” (step #11), and compares the modulation system in the data C with that in the data B (step #12). When the modulation system in the data C is different from that in the data B (YES in step #12), the primary controller 8 further compares source ID in the data C with that in the data B (step #13). When the source ID in the data C coincides with that in the data B (YES in step #13), the primary controller 8 sets the addition or deletion flag in the data B in deletion (step #14). Thereby, the addition or deletion flag of the channel 3 is set in deletion as shown in FIG. 2A, for example. In other words, since the addition and deletion flag of a channel of analogue broadcasting among a plurality of channels having the same source ID but the modulation systems thereof are different is set in deletion, the channel of analogue broadcasting is disabled to be selected in the up-and-down channel selection.

Alternatively, when the source IDs of the data B and data C are not coincided with each other (NO in step #13), the primary controller 8 takes a name of TV station of the data B referring to the source ID of the data B (steps #15 and #16), and judges whether the name of the TV station has a subjoinder (SD) at ending thereof or not (step #17). When the name of the TV station has the subjoinder (SD) at ending thereof (YES in step #17), the primary controller 8 deletes the subjoinder (SD) from the ending of the name of the TV station (step #18) and proceeds to step #19. Alternatively, when the name of the TV station has no subjoinder (SD) at ending thereof (NO in step #17), the primary controller 8 skips the step 18 and proceeds to the step #19.

Furthermore, the primary controller 8 takes a name of TV station of the data C referring to the source ID of the data C (steps #19 and #20), and judges whether the name of the TV station has a subjoinder (HD) at ending thereof or not (step #21). When the name of the TV station has the subjoinder (HD) at ending thereof (YES in step #21), the primary controller 8 deletes the subjoinder (HD) from the ending of the name of the TV station (step #22) and proceeds to step #23. In the step #23, the primary controller 8 compares the name of the TV station of the data B other than the subjoinder (SD) with the name of the TV station of the data C other than the subjoinder (HD). When the name of the TV station of the data B coincides with that of the data C (YES in step #23), the primary controller 8 sets the addition or deletion flag in the data B in deletion (step #14), and proceeds to step #24. Thereby, the addition or deletion flag of the channel 5 is set in deletion as shown in FIG. 2A, for example. In other words, when a plurality of channels each have different modulation system and difference source ID in the channel information but have the same name of TV station other than subjoinder, the addition or deletion flag of an analogue channel among them is set in deletion, and thus, the channel of analogue broadcasting is disabled to be selected in the up-and-down channel selection.

In addition when the judgment in each of the steps #12, #16, #20 and #24 is NO, the primary controller 8 proceeds to the step #24. The processes from step #11 to #23 are repeated for all the channels registered in the channel map information (NO in step #24), and after that, the primary controller 8 completes the channel selection disabling process.

As mentioned above, according to the broadcast signal receiving apparatus 1 in this embodiment, when the up key 21a or the down key 21b is operated by the user, the primary controller 8 serving as the channel selector confirms the condition of the addition or deletion flag of each channel and judges whether the channel should be reflected or not in the channel selecting operation or not corresponding to the condition of the addition or deletion flag, so that it enables to simplify the process in the primary controller 8. Thereby, although an inexpensive processor which is not so high-speed can be used for the primary controller 8, it is possible to simplify the operation by the user in the up-and-down channel selection and to increase the usability of the broadcast signal receiving apparatus 1.

Furthermore, when there is a plurality of channels having the same source ID in the channel map information, an addition or deletion flag of a channel according to digital modulation system is set in addition, and an addition or deletion flag of a channel according to analog modulation system is set in deletion. Thereby, the channel of digital modulation system of high grade is reflected in the up-and-down channel selection, but the channel of analogue modulation system is not reflected in the up-and-down channel selection.

Still furthermore, when a plurality of channels having the same name of TV station other than subjoinder HD or SD exists, the addition or deletion flag of the channel having the subjoinder HD at the ending of the name of the TV station is set in addition, and the addition or deletion flag of the channel having the subjoinder SD at the ending of the name of the TV station is set in deletion. Thereby, even when analogue broadcasting and digital broadcasting having the same contents but different source IDs are delivered from the same TV station, the channel according to the digital broadcasting of high grade can be reflected in the up-and-down channel selection and the channel according to the analogue broadcasting cannot be reflected in the up-and-down channel selection.

The present invention is not limited to the above mentioned embodiment, and the broadcast signal receiver in accordance with the present invention is sufficient to be configured such that the primary controller 8 serving as the channel selector confirms the addition or deletion flag of each channel when the up key 21a or the down key 21b is operated by the user, and the channel that the addition or deletion flag is set in deletion is not reflected in the up-and-down channel selection. In addition, the broadcast signal receiving apparatus 1 in accordance with the present invention can be applied to various kinds of television broadcast signal receiver such as terrestrial digital broadcasting and satellite digital broadcasting.

This application is based on Japanese patent application 2007-155428 filed Jun. 12, 2007 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A broadcast signal receiving apparatus comprising:
a video and audio signal receiver that receives video signals and audio signals included in broadcast signal;
a control signal receiver that receives broadcast control signal included in the broadcast signal;
a control signal processor that processes the broadcast control signal;
a channel map information creature that creates channel map information including information of channels, broadcast signals of which are receivable based on signals processed by the control signal processor;
a memory that stores the channel map information;
up and down keys used by a user to select a channel that broadcast signal thereof is received by the video and audio signal receiver; and
a channel selector that select the channel corresponding to operation of the up or down key operated by the user, wherein
the channel map information includes am addition or deletion flag for each channel registered in the channel map information by the channel selector, which is used to judge whether the channel is reflected in channel selecting operation or not when the up or down key is operated by the user;
when the addition or deletion flag of a channel is in addition, the channel selector reflects the channel in the channel selecting operation; and
when the addition or deletion flag of a channel is in deletion, the channel selector does not reflect the channel in the channel selecting operation.

2. The broadcast signal receiving apparatus in accordance with claim 1, wherein
the channel map information includes information relating to analogue modulation system or digital modulation system and a source ID corresponding to a television station from which broadcast signal is delivered for each channel; and
when a plurality of channels having the same source ID exists in the channel map information, the channel selector sets an addition or deletion flag of a channel according to digital modulation system in addition and sets an addition or deletion flag of a channel according to analogue modulation system in deletion.

3. The broadcast signal receiving apparatus in accordance with claim 1, wherein
the channel map information includes a name of television station from which broadcast signal is delivered for each channel;
the name of television station from which digital broadcast signal is delivered includes a subjoinder showing digital broadcasting and the name of television station from which analogue broadcast signal is delivered includes a subjoinder showing analogue broadcasting; and
when a plurality of channels having a same name of television station other than subjoinder exists in the channel map information, the channel selector sets an addition or deletion flag of a channel having a name of television station including the subjoinder showing digital broadcasting in addition and sets an addition or deletion flag of a channel having a name of television station including the subjoinder showing analogue broadcasting in deletion.

4. The broadcast signal receiving apparatus in accordance with claim 2, wherein
the channel map information includes a name of television station from which broadcast signal is delivered for each channel;
the name of television station from which digital broadcast signal is delivered includes a subjoinder showing digital broadcasting and the name of television station from which analogue broadcast signal is delivered includes a subjoinder showing analogue broadcasting; and
when a plurality of channels having a same name of television station other than subjoinder exists in the channel map information, the channel selector sets an addition or deletion flag of a channel having a name of television station including the subjoinder showing digital broadcasting in addition and sets an addition or deletion flag of a channel having a name of television station including the subjoinder showing analogue broadcasting in deletion.
